(19) United States
(12) Patent Application Publication
(10) Pub. No.: US 2017/0076382 A1
(43) Pub. Date: Mar. 16, 2017

(54) SYSTEM FOR DYNAMIC GENERATION OF ALLOCATION GUIDE FOR ASSETS

(71) Applicant: BANK OF AMERICA CORPORATION, Charlotte, NC (US)

(72) Inventors: Katherine Dintenfass, Charlotte, NC (US); Scott R. Enscoe, Charlotte, NC (US); Alicia C. Jones-McFadden, Fort Mill, SC (US); Matthew Hsieh, Charlotte, NC (US); Kevin Andrew O'Neil, JR., Hamilton, NJ (US); William F. Borowski, Millbury, MA (US); Minh Nguyen Vuong, Clovis, CA (US)

(21) Appl. No.: 14/853,600

(22) Filed: Sep. 14, 2015

(51) Int. Cl. G06Q 40/06

(52) U.S. Cl. CPC G06Q 40/06

(57) ABSTRACT

Embodiments of the invention are directed to systems, methods, and computer program products for dynamic generation of allocation guide for assets. The system is configured for receiving information associated with a state residency of the user; retrieving one or more state laws associated with the state residency of the user; retrieving information associated with allocation of assets from the one or more sources to the one or more accounts associated with the one or more beneficiaries; dynamically generating a will draft; and transmitting the will draft to the user.

### FIELD

The present application relates generally to allocating assets. Specifically, the present application relates to assessment of allocated assets by transforming information received from one or more sources of user assets in real-time.

### BACKGROUND

Asset management, broadly defined, refers to a system that monitors and maintains items of value to an individual, entity, or a group. Allocation of assets after a user's death involves a tremendous amount of paperwork. Storing, managing, and retrieving information in this mountain of paper is time-consuming and costly. There is a need for a system for efficiently retrieving asset information from multiple sources for determining transfer of assets and tracking asset lineage.

### BRIEF SUMMARY

Embodiments of the present invention address the above needs and/or achieve other advantages by providing apparatuses (e.g., a system, computer program product, and/or other device) and methods for a system to determine and transfer assets by transforming information received from one or more sources of user assets in real-time.

In one aspect, a system for dynamic generation of allocation guide for assets is presented. The system comprises at least one non-transitory storage device; at least one processor; and at least one module stored in said storage device and comprising instruction code that is executable by the at least one processor and configured to cause said at least one processor to: receive an indication from a user to initiate a will generation application on a user system; receive information associated with a state residency of the user; electronically retrieve one or more state laws associated with the state residency of the user; establish a communication link between the user system and one or more sources of user assets; retrieve information associated with allocation of assets from the one or more sources of user assets; dynamically generate a will draft based on at least the retrieved information and the one or more state laws, wherein the will draft comprises information associated with the allocation of the assets from the one or more sources of user asset to one or more beneficiaries or one or more accounts associated with the one or more beneficiaries; and electronically store the will draft for the user.

In some embodiments, establishing the communication link further comprises establishing a communication link with the one or more accounts associated with one or more beneficiaries.

In some embodiments, the module is further configured to: receive a user selection of at least one source of user assets from the one or more sources of user assets, wherein the user selection of the at least one source of user assets indicates that the user wishes to reallocate at least a portion of asset values from at least one source of user assets to the one or more beneficiaries or the one or more accounts associated with the one or more beneficiaries.

In some embodiments, the module is further configured to receive a user selection of at least one beneficiary from the at least one or more beneficiaries or at least one beneficiary account from the at least one or more accounts associated with the beneficiaries, wherein the user selection indicates that the user wishes to reallocate at least a portion of asset values from the one or more sources of user assets to the at least one beneficiary or the at least one beneficiary account.

In some embodiments, the module is further configured to determine transaction costs associated with the reallocation of at least a portion of asset values from the at least one source of user assets selected by the user to the one or more beneficiaries or the one or more accounts associated with the one or more beneficiaries.

In some embodiments, wherein the module is further configured to: receive an allocation percentage for the one or more beneficiaries or the one or more accounts associated with the one or more beneficiaries; and determine an asset value for reallocation from the at least one source of user assets to the one or more beneficiaries or the one or more accounts associated with the one or more beneficiaries based on the allocation percentage.

In some embodiments, the module is further configured to: continuously monitor the one or more sources of user assets; continuously monitor a financial status of the one or more beneficiaries based on the one or more accounts associated with the one or more beneficiaries; transform asset information from the one or more sources of user accounts and the financial status into a data format for display within the will generation application; and initiate presentation of a user interface on a user system, wherein the user interface displays the asset information and the financial status.

In some embodiments, the module is further configured to: dynamically update the will draft into an updated will draft based on changes in the allocation of assets from the one or more sources of user assets to the one or more beneficiaries or the one or more accounts associated with the one or more beneficiaries; and electronically store the updated will draft along with the will draft.

In another aspect, a computer program product for dynamic generation of allocation guide for assets is presented. The computer program product comprising a non-transitory computer-readable medium comprising code causing a first apparatus to: receive an indication from a user to initiate a will generation application on a user system; receive information associated with a state residency of the user; electronically retrieve one or more state laws associated with the state residency of the user; establish a communication link between the user system and one or more sources of user assets; retrieve information associated with allocation of assets from the one or more sources of user assets; dynamically generate a will draft based on at least the retrieved information and the one or more state laws, wherein the will draft comprises information associated with the allocation of the assets from the one or more sources of user asset to one or more beneficiaries or one or more accounts associated with the one or more beneficiaries; and electronically store the will draft for the user.

In yet another aspect, a computer implemented method for dynamic generation of allocation guide for assets is presented. The method comprising receiving an indication from a user to initiate a will generation application on a user system; receiving information associated with a state residency of the user; electronically retrieving one or more state laws associated with the state residency of the user; establishing a communication link between the user system and one or more sources of user assets; retrieving information associated with allocation of assets from the one or more sources of user assets; dynamically generating a will draft based on at least the retrieved information and the one or more state laws, wherein the will draft comprises information associated with the allocation of the assets from the one or more sources of user asset to one or more beneficiaries or one or more accounts associated with the one or more beneficiaries; and electronically storing the will draft for the user.

### BRIEF DESCRIPTION OF THE DRAWINGS

Having thus described embodiments of the invention in general terms, reference will be made to the accompanying drawings, where:

FIG. 1 illustrates a an exemplary block diagram of the system environment for implementing the process flows described herein in accordance with embodiments of the present invention;

FIG. 2 illustrates a high level process flow for assessment of allocated assets by transforming information received from one or more sources of user assets in real-time, in accordance with an embodiment of the invention;

FIG. 3 illustrates a high level process flow for determination and tracking of asset lineage, in accordance with embodiments of the present invention;

FIG. 4A illustrates a typical first interface for an estate portal, in accordance with an embodiment of the invention; and

FIG. 4B illustrates a typical second interface for the estate portal, in accordance with an embodiment of the invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As used herein, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity.

As used herein, an “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity.

As used herein, “assets” include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like.

As used herein, “liabilities” are cash or cash equivalent debt that a user may owe to an entity. Examples of liabilities may include a home mortgage, another type of loan for which the user has to make payments, payments owed to the government, a legal judgment against the user, or any other situation in which the use owes a debt to another entity or person.

The combination of assets and liabilities may be described herein as “finances” of a user.

As used herein, a “user” may be a financial institution customer (e.g., an account holder or a person who have an account (e.g., banking account, credit account, or the like)). In one aspect, a user may be any financial institution customer associated with the financial institution or any other affiliate entities associated with the financial institution. In some embodiments, the user may be an individual who may be interested in opening an account with the financial institution. In some other embodiments, a user may be any individual who may be interested in enrolling in a specific financial program offered by the financial institution. For purposes of this invention, the term “user” and “customer” may be used interchangeably.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, a “web portal” is a specially designed web page that brings information together from a variety of sources in a uniform way. Typically, each information source is designed to have a dedicated area on the page for displaying information. The extent to which content is displayed in a “uniform way” may depend on the intended user and the intended purpose, as well as the diversity of the content.

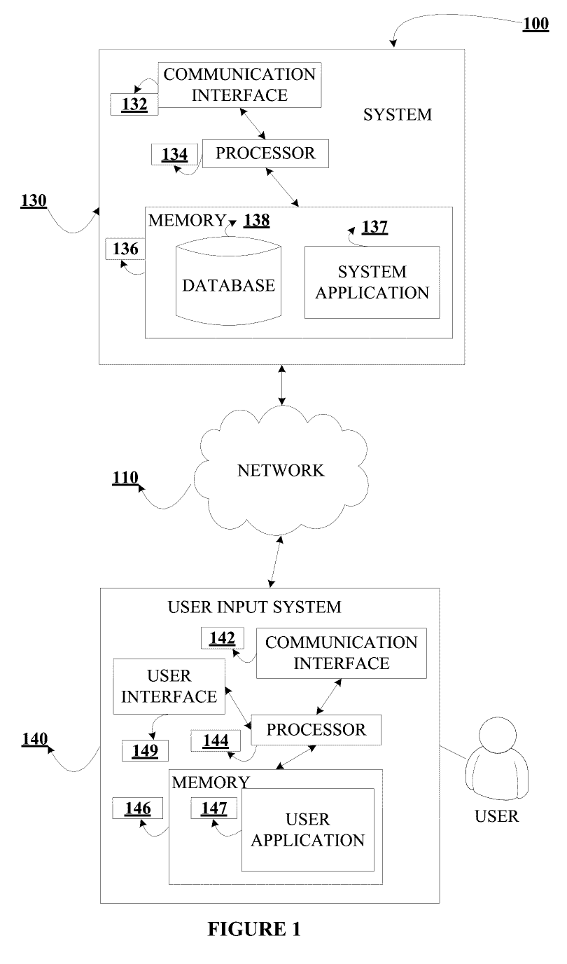

FIG. 1 presents a typical block diagram of the system environment 100 for implementing the process flows described herein in accordance with embodiments of the present invention. As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the system 130. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, Wi-Fi triangulation system, or the like) may enable at least the user input system 140 or an external server or computing device in communication with the user input system 140 to determine the location (e.g. location coordinates) of the user input system 140.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. In this regard, the system may utilize the volatile memory over the non-volatile memory by storing multiple pieces of information in the volatile memory, thereby reducing the load on the system and increasing the processing speed.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments the input/output devices may be the same device or a combinations of devices that allow for the input or output of information to or from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the entity (e.g., a business). The system 130 may be located at the facility associated with the business or remotely from the facility associated with the business. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is typical and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein.

It should be further understood that the system 130 may be a single system, or there may be multiple systems 130, each with the capabilities of the system 130 described herein, and each of which are connected through a network. As such, the system environment 100 may include one or more financial institution systems, one or more other financial institution systems, one or more merchant systems, one or more third-party systems, one or more other entity systems, each of which may be utilized to send or receive information or other be used with respect to the processes, and steps thereof, described herein.

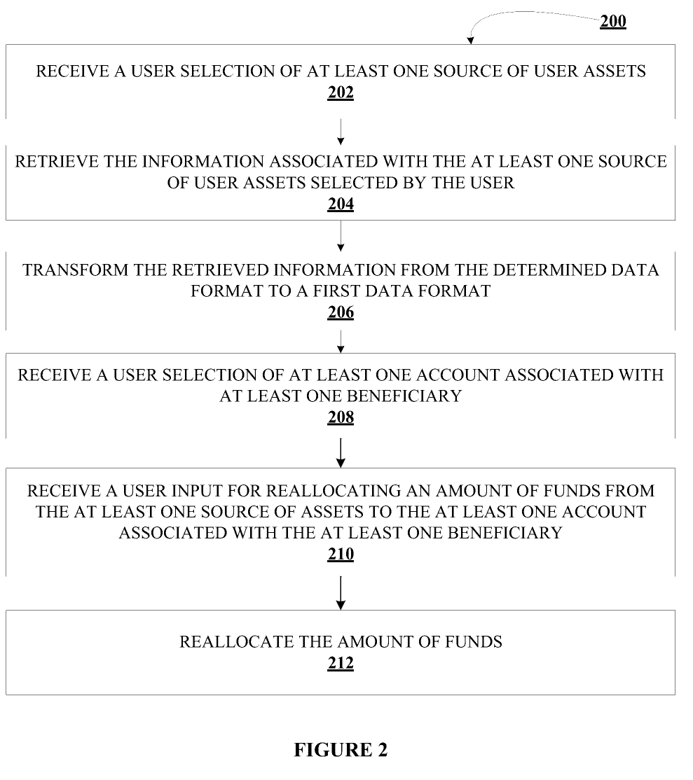

FIG. 2 illustrates a process flow for assessment of allocated assets by transforming information received from one or more sources of user assets in real-time 200, in accordance with an embodiment of the invention. In one aspect, the assets may be assessed using an estate portal application via user input system (e.g., the mobile device of the user, or other computer system). In some embodiments, the system may be configured to allow a user to access the estate portal application through a web browser. In other embodiments, the system may be configured to provide an estate portal application to be installed on a user input system associated with a user.

The user may commence the process flows described herein by initiating the estate portal application through a portion of the application stored on the user input system or through a web browser located on the user input system. In response, the system may be configured to initiate presentation of a first user interface, wherein the first user interface includes one or more sources of user assets. In one aspect, the each of the one or more sources is associated with a data format. Typically, data format includes the organization of information according to present specifications. In some embodiments, the user's assets may include but are not limited to checking accounts, savings accounts, investment accounts (e.g., with regular disbursements and penalties for principal withdrawals, or self-directed accounts that are liquid without penalties), annuity accounts (e.g., social security, claim awards, reverse mortgages, or the like), insurances benefit accounts (e.g., one time or reoccurring), property owned by the user (e.g., investment property, rental property, or the like), or other like assets that may provide regular or semi-regular recurring payments, assets that are or are similar to cash accounts, or assets that need to be sold in order to realize cash values of the assets. In some embodiments the assets may be illiquid (e.g., have penalties or may take time to convert into cash) or may be liquid (e.g., can be converted to cash immediately or within hours, days, or the like without penalty). In addition, embodiments of the invention further comprise determining a user's liabilities and the values (e.g., amount of debt, or the like) of the liabilities (e.g., amount owed, or the like). The user's liabilities may include a mortgage, long and short term debt (e.g., credit card debt, car loans, boat loans, small business loans, lines of credit, or the like), payments owed on other personal property or legal judgments against the user, or the like. In some embodiments these assets and liabilities may be automatically determined if the assets and liabilities are held with the financial institution providing the estate portal application. However, in the instances when an entity providing the estate portal application does not hold the assets or liabilities of the user or when the user has multiple assets and liabilities with multiple institutions, the user may allow the financial institution or other entity access to the user's assets and liabilities (e.g., by providing the login and password to the accounts of the user at the different institutions). In some embodiments, based on the types of assets and liabilities and the entities that through which they are provided, information associated with each of the assets and liabilities may be stored in multiple independent databases.

As previously discussed the assets and liabilities may be presented to the user in one or more interfaces through the estate portal application. In addition to presenting the assets and liabilities of a user, the system may also present the assets and liabilities of the beneficiaries (e.g., or more other users) of the assets of the user. Typically, a beneficiary is a person or entity named in a will or testament to receive money or other benefits from a benefactor. For purposes of the invention, the benefactor is the user. For example, the beneficiary of a life insurance policy is the person who receives the payment of the amount of insurance after the death of the insured. The beneficiaries of the user may be related to the user or may be others that are not related to the user. Most beneficiaries may be designed to designate where the assets will go when the owner(s) dies. However, if the primary beneficiary or beneficiaries are not alive or do not qualify under the restrictions, the assets will probably pass to the contingent beneficiaries. In some embodiments, the beneficiaries may allow the financial institution or entity to access the finances of the beneficiaries or to view or determine an indication of the finances of the beneficiaries (e.g., credit worthiness, score, or the like) in order to provide a financial status of the beneficiaries to the first user. As such in some embodiments the first user may have access to the financial status (e.g., finances, credit worthiness, indications of finances, or the like) of the beneficiaries. The financial status may be updated in real time to provide an accurate value to the first user.

In some embodiments, the beneficiaries may be provided with information associated with the user's assets and liabilities. In this regard, the user may configure the transparency of the information being provided to the one or more beneficiaries. For example, the user (a parent), may configured the system in such a way that the beneficiaries (a child) may be able to view the existence of a real estate asset but not be able to view the value of the real estate asset until after the child turns 21. In this way, the beneficiaries may be able to better assess their own finances based on at least a portion of the user's assets and liabilities that they may receive as inheritance now or in the future (after the user's death). In one aspect, the beneficiaries may provide input regarding an asset type that they may want to inherit. Asset types may include, but are not limited to, real estate (e.g., house, condo, warehouse, or the like), jewelry, furniture, and/or financial assets (e.g., stocks, bonds, or the like). In this regard, system may be configured to provide asset tracking features for mobile assets (e.g., furniture, an expensive car, jewelry, or the like). Asset tracking typically refers to tracking the method of physical assets, either by scanning barcode labels to the assets or by using tags using GPS or RFID which broadcast their location. In another aspect, the beneficiaries may decline to inherit one or more user assets and liabilities.

As illustrated by block 202 the system may be configured to establish a communication link with the at least one source of user assets and/or the one or more sources of the financial status of the beneficiaries, such as entities (e.g., regulating entity, financial institutions, or the like), in order to monitor the finances of the user and/or the financial status of the user and/or beneficiaries. The link may be an internal link within the same financial institution or a link with an unrelated financial institution or another entity. In some embodiments, the system may be configured for selectively monitoring one or more real-time data feeds from the one or more sources of user assets and financial status of the beneficiaries. These feeds can be provided via wireless network path portions through the Internet. When the system is not monitoring a source, the data need not be transmitted from the sources to the Internet, although it could be. Indeed, “continuously available” does not necessarily mean that the sources actually continuously generate data, but that a source is continuously available to generate and send data real-time (i.e., within a few seconds) of receiving a request for it. In any case, the sources are continuously available to generate data, preferably digitized data in Internet Protocol (IP) packet format. In response to continuously monitoring the real-time data feeds, the system may be configured to update the asset value associated with the one or more sources of user assets and/or financial status of the beneficiaries in real-time for display on the estate portal application. As explained in further detail later, the information associated with the user assets from the one or more sources of user assets, and the financial status of the one or more beneficiaries from the one or sources of financial status of beneficiaries may be various data formats that can be transformed into a data format associated with the estate portal. This data capture and transformation may occur in real-time and/or any time a user asset selection, beneficiary asset selection, or the like. In one aspect, the captured data may provide information indicating which of the user's assets and/or liabilities are currently owned by the user and which of them are mortgaged to a third party.

Typically, a financial status may be determined based on a number of assets of the one or more beneficiaries, such as types of accounts, investments, annuities, property, or the like that may provide a stream of income (or negative steam of income) or payments over a period of time, but which may also be illiquid or otherwise difficult to convert into cash. In this way, the net worth of each of the one or more beneficiaries may be determined. In response to determining the financial status of the one or more beneficiaries, the financial status may be displayed via the estate portal on the user input system (e.g., a computer system, mobile device, or the like of the user. In some embodiments, the system may establish one or more thresholds to determine a financial status of the one or more beneficiaries.

Next, the process flow includes receiving a user selection of at least one source of user assets from the one or more sources of user assets, as shown in block 204. In some embodiments, the user selection of the at least one source of user assets indicates that the user wishes to utilize asset value of the at least one source of user assets for allocation or reallocation to one or more beneficiaries. For example, the financial status of the beneficiaries may have changed, and as such, the user may want to reallocate the assets to different beneficiaries. In response to receiving the user selection, the system may retrieve the information associated with the at least one source of user assets selected by the user, as shown in block 206. In some embodiments, retrieving information associated with the at least one source of user assets includes retrieving information about an asset value associated with the at least one source of user assets. In this regard, the system may be configured to retrieve the information from a distributed network of servers, wherein each server may be associated with a financial institution account of the user. In some embodiments, the information retrieval process begins when a user enters a query into the system. In doing so, several objects may match the query, perhaps with different degrees of relevancy. Depending on the application the data objects may be, for example, text documents, images, audio, video, or the like. Each data object may be associated with a data format depending upon the source of the user assets. In some embodiments, the data objects retrieved from the one or more sources of user assets may be encrypted. In such instances, the system may be configured to decrypt the data objects prior to the execution of the information retrieval process.

Next, the process flow includes transforming the retrieved data related to the financial assets of the user from the determined data format to a data format associated with the estate portal application for display on the estate portal application, as shown in block 208, in some embodiments this occurs in real time. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times third program may be available which permits the conversion to an intermediate format, which can then be reformatted using the first program.

In some embodiments, in response to selecting a user asset, the system initiates a presentation of the beneficiaries in an interface (e.g., the same interface or in a second user interface). The process flow further includes receiving a user selection of at least one beneficiary (e.g., select the beneficiary or one account associated with at least one beneficiary), as shown in block 210. In some embodiments, the system of the present invention may simply update the one or more beneficiaries of the asset of the user, such that upon the user's death and/or the execution of the user's will through the executor the assets may be automatically transferred to the beneficiary. In other embodiments, the system may be configured to transfer assets before the user's death for transaction cost purposes. As such, in some embodiments the system may then be configured to establish a communication link with the at least one account associated with the at least one beneficiary, thereby creating a communication channel between the at least one source of user assets selected by the user and the at least one account associated with the at least one beneficiary selected by the user.

Next, as shown in block 212, the process flow includes receiving a user input for reallocating at least an amount associated with asset value from the at least one source of assets to the at least one account associated with the at least one beneficiary. In some embodiments, the user may assign an allocation percentage for each account associated with a beneficiary. In some embodiments, the system may be configured to determine the transaction cost implications of transferring assets immediately or after the user has passed away. As such, the system may determine if the user should transfer some assets immediately; however, alternatively, the desired transfer of assets may be saved and stored for when the user passes away.

In response to receiving a user input, the process flow includes reallocating the amount associated with the asset value retrieved from the at least one source of user assets selected by the user to the at least one account associated with the at least one beneficiary, as shown in block 214. As previously discussed the allocation may occur immediately, or may be saved and stored in order to transfer the assets upon death. In this way, the present invention allows the user may make an informed decision to reallocate funds from at least one source of user assets to one or more accounts associated with a beneficiary based on the financial status of the at least one beneficiary, in a real-time basis.

In addition to the estate portal application, in some embodiments, the system may be configured to dynamically prepare and generate a will draft and/or a text of complex documents with alternative text provisions, insertable text and/or multiple provisions that are selected in response to information relevant to the preparation of the will draft. Today, documents of this type, for example, loan commitment letters, wills and testaments, are typically prepared by selecting a form and/or examples of such letters from prior transactions and then “cutting and pasting” the required provisions into the document, modifying those provisions to reflect the terms of the financing and then editing the entire agreement. In this instance, the information relevant to the preparation of the will draft includes the one or more sources of user assets, percentage allocation, one or more beneficiaries, and one or more accounts associated with the one or more beneficiaries. In some embodiments, the system may be configured to present the user with a series of questions to aid in the generation of the will draft. For example, types of assets, list of beneficiaries, relationship of the user to each beneficiary, or the like. In this regard, the will draft may be generated efficiently based upon providing responses to a series of questions.

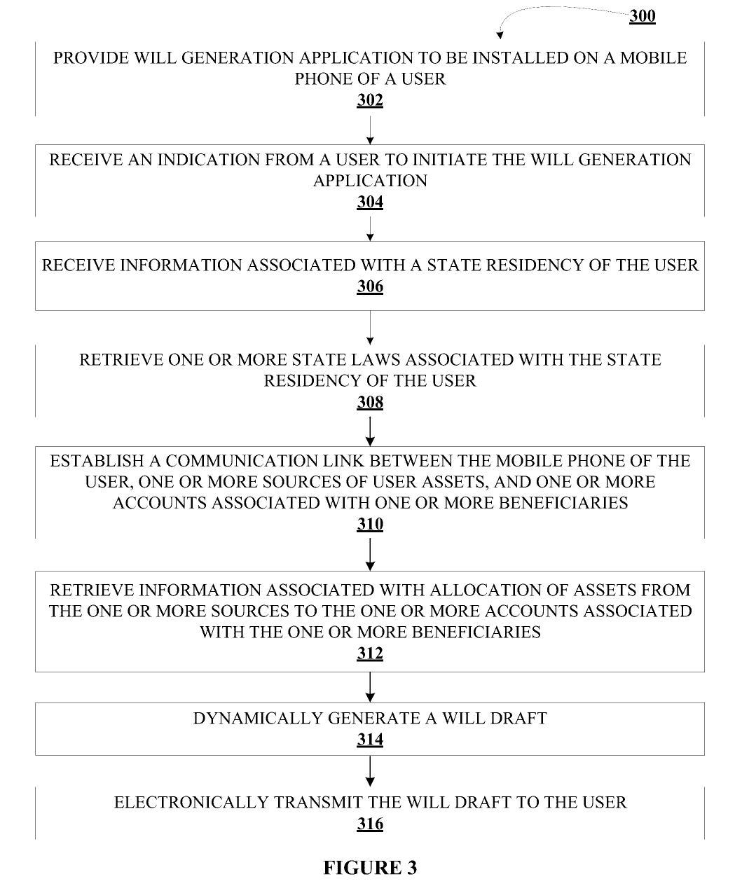

FIG. 3 illustrates a high level process flow for dynamically retrieving information for drafting a will 300, in accordance with an embodiment of the invention. As shown in block 302, the process flow includes providing a will generation application. The will generation application may be same as the estate portal application, a function within the estate portal application, another application that interfaces with the estate portal application, or another application entirely. The will generation application, like the estate portal application may be accessed through a web browser or be installed on a user input system (e.g., a computer, a mobile phone, or the like of the user). Next, the process flow includes receiving an indication from a user to initiate the will generation application, as shown in block 304. This indication may be received by the system via the estate portal application. In this way, the system may be configured to establish a data connection with the one or more sources of user assets to retrieve information and continue with the process flow described below. Next, the process flow includes receiving information associated with a state residency of the user, as shown in block 306. Typically, a will has the same function regardless of the user's state of residence, but may be subjected to variations by state. For example, a will cannot require an heir to commit an illegal, immoral, or other act against public policy as a condition of receiving an inheritance. Similarly, some states have laws against omitting certain beneficiaries from an estate, such as a surviving spouse. As such, the system takes into account the state laws and regulations for the effective and accurate generation of the will draft. Next, as shown in block 308, the process flow includes retrieving one or more state laws associated with the residency of the user.

In response, the process flow includes establishing a communication link between the user input system (e.g., a computer, mobile phone, or the like of the user), one or more sources of user assets, and one or more accounts associated with one or more beneficiaries, as shown in block 310. In response to establishing a communication link, the process flow includes retrieving information associated with allocation of assets from the one or more sources to the one or more beneficiaries and/or to the one or more accounts associated with the one or more beneficiaries, as shown in block 312. The information may be pre-stored based on the allocations created through the estate portal application described with respect to FIG. 2. However, in other embodiments the present invention may allow the user change any of the allocations before creating the will. As such, in some embodiments, a user may select at least one source of user assets indicating that the user wishes to utilize funds from the selected source of user assets for reallocation to one or more user selected beneficiaries and/or beneficiary accounts associated with one or more beneficiaries. In this regard, the system may be configured to receive an allocation percentage for the at least one account associated with at least one beneficiary to determine at least an amount associated with the asset value for reallocation from the at least one source of user assets to the at least one account associated with the at least one beneficiary based on at least the allocation percentage.

Next, the process flow includes dynamically generating a will draft based on at least the retrieved information, the answers to the questions posed to the user, and the one or more state laws, as shown in block 314. In one aspect, the will draft comprises information associated with allocation of assets from the one or more sources to the one or more accounts associated with the one or more beneficiaries. In some instances, the system may be configured to generate an alert when there is a conflict between the state law and the asset allocation. In some embodiments, the system may be configured to trigger the will generation application on the user input system (e.g., computer, mobile device, or the like of the user) to initiate the display of the alert, thereby indicating to the user that there's a discrepancy between the current asset allocation and the state laws. In one aspect, the system may be configured to retrieve current state laws and accurately identify the discrepancy. In some embodiments, in response to identifying the discrepancy, the system may provide recommendations to help the user rectify the discrepancy. In response to drafting the will, the process flow includes electronically transmitting the will draft to the user, as shown in block 316.

In some embodiments, the system may be configured to enable the user to generate an electronic version of will draft. In one aspect, the generated will draft may be stored or saved to be retrieved in the event of the user's death. In some embodiments, the user may generate multiple will drafts over time based on a different selection of at least the source of user assets and the beneficiaries (or the accounts of the beneficiaries) and/or changes in the allocation of the assets. In this way, the user may be able to save multiple versions of the will draft and collectively be able to review the multiple versions by accessing the estate portal application.

In some embodiments, the system may be configured to incorporate one or more trigger events in the generation of the will. In this regard, the user may generate multiple versions of the will draft according to each triggering event specified by the user. For example, the user (a parent) may draft a will stating that a funds associated with the user's financial assets will be managed by a third party (e.g., a trust) in lieu of a beneficiary (a child) if the child is underage or is in some form unable to manage funds responsibly. In another example, the beneficiary (a parent) may draft a will stating that an asset (e.g., a house) may be inherited by a beneficiary (a child) if the child gets married by the age of 25 and has stayed married for at least 5 years. In doing so, the user may utilize the trigger event to determine whether the beneficiary is deemed able to manage the funds and/or assets responsibly.

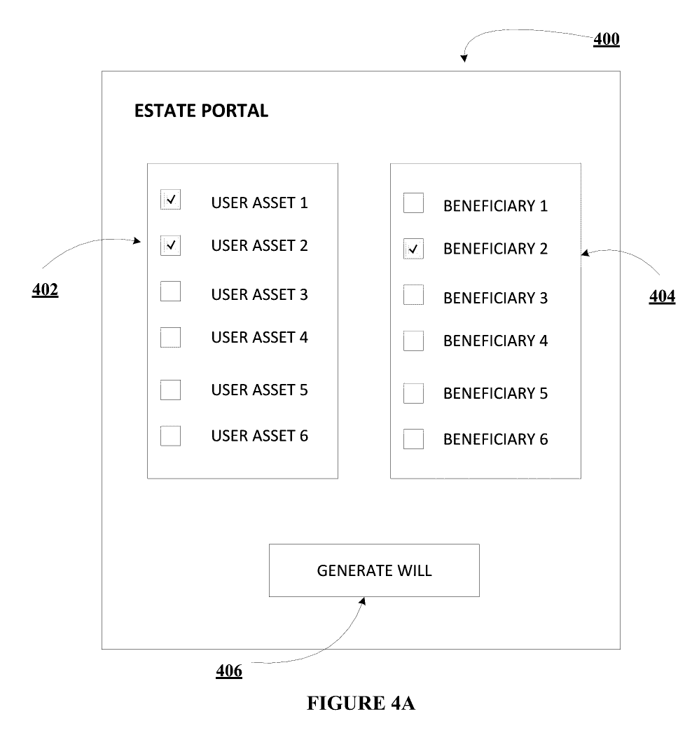

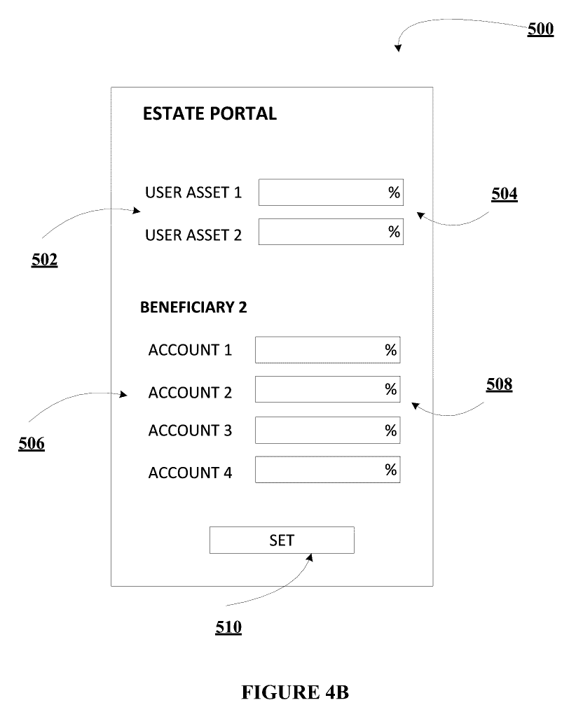

FIG. 4A illustrates a typical embodiment for a first interface of the estate portal 400, in accordance with an embodiment of the invention. As shown, the first interface includes one or more sources of user assets 402, one or more beneficiaries (or one or more accounts associated with one or more beneficiaries) 404, and an option to generate a will draft 406. The user may select at least one source of user assets and at least one beneficiary. In some embodiments this interface may illustrate information associated with the user assets (e.g., amount asset value, type of account, or the like) and/or the financial status of the beneficiaries. In another embodiment, this interface may enable the user to establish the communication link, via a wireless data channel to connect with the source of user assets, one or more beneficiaries or one or more accounts of the beneficiaries. In one aspect, the first user interface may enable the user to add one or more beneficiaries or one or more accounts of one or more beneficiaries to the estate portal.

FIG. 4B illustrates a typical embodiment for a second interface of the estate portal 500, in accordance with an embodiment of the invention. As shown, the second interface includes the selected sources of user assets 502, percentage allocation associated with each user asset 504, one or more accounts associated with the selected beneficiary 506, percentage allocation associated with each account, and an option to set the values 510. In some embodiments, the user may assign a percentage to the portion of asset values associated with each user asset. In this way, when the assets are being reallocated to one or more beneficiaries or one or more accounts associated with the one or more beneficiaries, the system may allocate the assets based on the percentage allocations. In some other embodiments, the user may assign a percentage allocation to the one or more accounts associated with a selected beneficiary. In this way, when a portion of user assets is being reallocated to the one or more accounts according to the percentage allocations.

In some embodiments, the system may be configured to transmit a notification to the user indicating that the user may have to update the estate portal application based on new information. For example, the new information may include a death of a beneficiary, change in state or regulatory laws since the generation of the previous will, change in the residency of the user, or the like. In some embodiments, the system may be configured to request one or more authentication credentials from the user to enable the user generate a draft of the will. In some embodiments, the authentication credentials may include, but are not limited to, at least one of a username, contact information, a password, a PIN number, biometric information (e.g., physiological features such as fingerprints, finger vein and palm vein patterns, as well as iris and facial recognition to verify individual identities), a unique identification number associated with the user, social network information, an account number, or a card number. In some embodiments, the user information may be proprietary to the financial institution, such as an account number, a reference number to an account, a client number, or the like. In other embodiments, the user information may be public information, such as a phone number, mailing address, email address, or the like. In this way, system may be configured to confirm the identity of the user and whether the user is of sound mind and health when generating the will draft.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent applications:

| | U.S. patent application | | |
|---|---|---|---|
| Docket Number | Ser. No. | Title | Filed On |
| 6810US1.014033.2511 | 14/851,750 | SYSTEM FOR RESTRUCTURING | Sep. 11, 2015 |
| | | BASED ON PREDICTIVE ANALYSIS | |
| 6811US1.014033.2512 | 14/851,758 | UNIVERSAL TOKENIZATION | Sep. 11, 2015 |
| | | SYSTEM | |
| 6812US1.014033.2513 | 14/851,599 | SYSTEM FOR MODELING AND | Sep. 11, 2015 |
| | | IMPLEMENTING EVENT- | |
| | | RESPONSIVE RESOURCE | |
| | | ALLOCATION STRUCTURES | |
| 6813US1.014033.2514 | 14/851,623 | SYSTEM FOR SIMULATION AND | Sep. 11, 2015 |
| | | IMPLEMENTATION OF DYNAMIC | |
| | | STATE-DEPENDENT RESOURCE | |
| | | RECONFIGURATION | |
| 6815US1.014033.2515 | 14/851,848 | SYSTEM FOR DYNAMIC | Sep. 11, 2015 |
| | | VISUALIZATION OF | |
| | | INDIVIDUALIZED CONSUMPTION | |
| | | ACROSS SHARED RESOURCE | |
| | | ALLOCATION STRUCTURE | |
| 6817US1.014033.2516 | 14/851,765 | SYSTEM FOR ANALYZING PRE- | Sep. 11, 2015 |
| | | EVENT AND POST-EVENT | |
| | | INDIVIDUAL ACCOUNTS AND | |
| | | TRANSFORMING THE ACCOUNTS | |
| 6818US1.014033.2517 | 14/851,769 | SYSTEM FOR OPENING AND | Sep. 11, 2015 |
| | | CONSOLIDATING ACCOUNTS | |
| | | BASED ON AN EVENT | |
| | | ASSOCIATED WITH THE ACCOUNT | |
| | | HOLDER | |
| 6824US1.014033.2518 | | SYSTEM FOR DETERMINATION | Concurrently |
| | | AND TRACKING OF ASSET | Herewith |
| | | LINEAGE | |
| 6825US1.014033.2519 | | SYSTEM FOR DETERMINATION | Concurrently |
| | | AND TRANSFER OF ASSETS | Herewith |
| 6826US1.014033.2520 | | SYSTEM FOR RESTRUCTURING | Concurrently |
| | | BASED ON INTENT ANALYSIS | Herewith |
| 6827US1.014033.2521 | | SYSTEM FOR ASSESSMENT OF | Concurrently |
| | | ALLOCATED ASSETS | Herewith |

What is claimed is:

1. A system for dynamic generation of allocation guide for assets, the system comprising:
at least one non-transitory storage device;
at least one processor; and
at least one module stored in said storage device and comprising instruction code that is executable by the at least one processor and configured to cause said at least one processor to:
receive an indication from a user to initiate a will generation application on a user system;
receive information associated with a state residency of the user;
electronically retrieve one or more state laws associated with the state residency of the user;
establish a communication link between the user system and one or more sources of user assets;
retrieve information associated with allocation of assets from the one or more sources of user assets;
dynamically generate a will draft based on at least the retrieved information and the one or more state laws, wherein the will draft comprises information associated with the allocation of the assets from the one or more sources of user asset to one or more beneficiaries or one or more accounts associated with the one or more beneficiaries; and
electronically store the will draft for the user.

2. The system of claim 1, wherein establishing the communication link further comprises establishing a communication link with the one or more accounts associated with one or more beneficiaries.

3. The system of claim 1, wherein the module is further configured to:
receive a user selection of at least one source of user assets from the one or more sources of user assets, wherein the user selection of the at least one source of user assets indicates that the user wishes to reallocate at least a portion of asset values from at least one source of user assets to the one or more beneficiaries or the one or more accounts associated with the one or more beneficiaries.

4. The system of claim 1, wherein the module is further configured to receive a user selection of at least one beneficiary from the at least one or more beneficiaries or at least one beneficiary account from the at least one or more accounts associated with the beneficiaries, wherein the user selection indicates that the user wishes to reallocate at least a portion of asset values from the one or more sources of user assets to the at least one beneficiary or the at least one beneficiary account.

5. The system of claim 4, wherein the module is further configured to determine transaction costs associated with the reallocation of at least a portion of asset values from the at least one source of user assets selected by the user to the one or more beneficiaries or the one or more accounts associated with the one or more beneficiaries.

6. The system of claim 1, wherein the module is further configured to:
receive an allocation percentage for the one or more beneficiaries or the one or more accounts associated with the one or more beneficiaries; and
determine an asset value for reallocation from the at least one source of user assets to the one or more beneficiaries or the one or more accounts associated with the one or more beneficiaries based on the allocation percentage.

7. The system of claim 1, wherein the module is further configured to:
continuously monitor the one or more sources of user assets;
continuously monitor a financial status of the one or more beneficiaries based on the one or more accounts associated with the one or more beneficiaries;
transform asset information from the one or more sources of user accounts and the financial status into a data format for display within the will generation application; and
initiate presentation of a user interface on a user system, wherein the user interface displays the asset information and the financial status.

8. The system of claim 1, wherein the module is further configured to:
dynamically update the will draft into an updated will draft based on changes in the allocation of assets from the one or more sources of user assets to the one or more beneficiaries or the one or more accounts associated with the one or more beneficiaries; and
electronically store the updated will draft along with the will draft.

9. A computer program product for dynamic generation of allocation guide for assets, the computer program product comprising a non-transitory computer-readable medium comprising code causing a first apparatus to:
receive an indication from a user to initiate a will generation application on a user system;
receive information associated with a state residency of the user;
electronically retrieve one or more state laws associated with the state residency of the user;
establish a communication link between the user system and one or more sources of user assets;
retrieve information associated with allocation of assets from the one or more sources of user assets;
dynamically generate a will draft based on at least the retrieved information and the one or more state laws, wherein the will draft comprises information associated with the allocation of the assets from the one or more sources of user asset to one or more beneficiaries or one or more accounts associated with the one or more beneficiaries; and
electronically store the will draft for the user.

10. The computer program product of claim 9, wherein the first apparatus is further configured to establish a communication link with the one or more accounts associated with one or more beneficiaries.

11. The computer program product of claim 9, wherein the first apparatus is further configured to receive a user selection of at least one source of user assets from the one or more sources of user assets, wherein the user selection of the at least one source of user assets indicates that the user wishes to reallocate at least a portion of asset values from at least one source of user assets to the one or more beneficiaries or the one or more accounts associated with the one or more beneficiaries.

12. The computer program product of claim 9, wherein the first apparatus is further configured to receive a user selection of at least one beneficiary from the at least one or more beneficiaries or at least one beneficiary account from the at least one or more accounts associated with the beneficiaries, wherein the user selection indicates that the user wishes to reallocate at least a portion of asset values from the one or more sources of user assets to the at least one beneficiary or the at least one beneficiary account.

13. The computer program product of claim 12, wherein the first apparatus is further configured to determine transaction costs associated with the reallocation of at least a portion of asset values from the at least one source of user assets selected by the user to the one or more beneficiaries or the one or more accounts associated with the one or more beneficiaries.

14. The computer program product of claim 9, wherein the first apparatus is further configured to:
receive an allocation percentage for the one or more beneficiaries or the one or more accounts associated with the one or more beneficiaries; and
determine an asset value for reallocation from the at least one source of user assets to the one or more beneficiaries or the one or more accounts associated with the one or more beneficiaries based on the allocation percentage.

15. The computer program product of claim 9, wherein the first apparatus is further configured to:
continuously monitor the one or more sources of user assets;
continuously monitor a financial status of the one or more beneficiaries based on the one or more accounts associated with the one or more beneficiaries;
transform asset information from the one or more sources of user accounts and the financial status into a data format for display within the will generation application; and
initiate presentation of a user interface on a user system, wherein the user interface displays the asset information and the financial status.

16. A computer implemented method for dynamic generation of allocation guide for assets, the method comprising:
receiving an indication from a user to initiate a will generation application on a user system;
receiving information associated with a state residency of the user;
electronically retrieving one or more state laws associated with the state residency of the user;
establishing a communication link between the user system and one or more sources of user assets;
retrieving information associated with allocation of assets from the one or more sources of user assets;
dynamically generating a will draft based on at least the retrieved information and the one or more state laws, wherein the will draft comprises information associated with the allocation of the assets from the one or more sources of user asset to one or more beneficiaries or one or more accounts associated with the one or more beneficiaries; and
electronically storing the will draft for the user.

17. The computer implemented method of claim 15, wherein establishing the communication link further comprises establishing a communication link with the one or more accounts associated with one or more beneficiaries.

18. The computer implemented method of claim 15, wherein the method further comprises receiving a user selection of at least one source of user assets from the one or more sources of user assets, wherein the user selection of the at least one source of user assets indicates that the user wishes to reallocate at least a portion of asset values from at least one source of user assets to the one or more beneficiaries or the one or more accounts associated with the one or more beneficiaries.

19. The computer implemented method of claim 16, wherein the method further comprises receiving a user selection of at least one beneficiary from the at least one or more beneficiaries or at least one beneficiary account from the at least one or more accounts associated with the beneficiaries, wherein the user selection indicates that the user wishes to reallocate at least a portion of asset values from the one or more sources of user assets to the at least one beneficiary or the at least one beneficiary account.

20. The computer implemented method of claim 19, wherein the method further comprises determining transaction costs associated with the reallocation of at least a portion of asset values from the at least one source of user assets selected by the user to the one or more beneficiaries or the one or more accounts associated with the one or more beneficiaries.
